(19) United States
(12) Patent Application Publication
(10) Pub. No.: US 2004/0241609 A1
(43) Pub. Date: Dec. 2, 2004

(54) Method of manufacturing high strength dental restorations

(76) Inventors: Weitao Jia, Wallingford, CT (US); Shuhua Jin, Wallingford, CT (US)

Correspondence Address: PENTRON CORPORATION, 53 NORTH PLAINS INDUSTRIAL ROAD, WALLINGFORD, CT, 06492, US

(21) Appl. No.: 10/839,696

(22) Filed: May 5, 2004

Related U.S. Application Data
(60) Provisional application No. 60/468,935, filed on May 8, 2003.

(51) Int. Cl. A61C 13/00

(52) U.S. Cl. 433/167; 264/16; 425/174.4

(57) ABSTRACT

Method of the making dental restorations having photo-initiated polymerizable dental compositions. The method comprises preheating a dental restoration precursor of a defined shape or anatomy in a temperature range from about 65°-120° C. for a length of time for the temperature to reach a temperature equilibrium. The time preferably ranges from about 1 minute to 30 minutes. Thereafter, the dental composition is light cured to polymerize the dental restoration. The restoration produced through this process will have at least 10% or higher strength than the dental restorations made by conventional methods.

### CROSS-REFERENCE TO RELATED APPLICATIONS

This application claims priority to U.S. application Ser. No. 60/468,935 filed May 8, 2003, entitled Method Of Manufacturing High Strength Dental Restorations.

### FIELD OF THE INVENTION

The present invention relates generally to methods of manufacturing dental restorations and more specifically to methods of manufacturing light curable polymeric composite dental materials.

### BACKGROUND OF THE INVENTION

Light curable dental restorative materials are composite compositions of unsaturated functional monomers and fillers that are formulated to be polymerized by photochemical action upon exposure to light. The compositions will typically polymerize upon application of light in the 300-500 nanometer range. These composites have exhibited good mechanical properties after polymerization has been affected. Moreover, polymerizing the composites in inert atmospheres, under compressed air or in a vacuum has further enhanced the mechanical properties.

U.S. Pat. Nos. 6,320,162 and 6,236,020 to Friedman, which are hereby incorporated by reference, are directed to a method and apparatus for preheating single dose units of photocurable materials prior to clinical usage to enhance the properties of the composite. The patents describe the principal advantages of the preheating step to be improved monomer conversion, improved material hardness, improved wear resistance, improved color stability, and improved strength. The inventor therein discovered that the reactive monomer in the photocurable material converted to a polymer in a substantially linear relationship over a temperature range from the refrigeration temperature of 20° F. to an elevated temperature of 150° F. Despite the advantages realized by this process, the inventor failed to note that by the time the photocurable material is delivered and shaped into a tooth cavity, the temperature of the material has cooled down to about 98° F. (body temperature). It is not much different than using an unheated photocurable material that will reach the temperature in the patient's mouth, i.e., 98° F., during insertion and before light curing. Moreover, the inventor cannot perform this procedure at temperatures higher than 150° F., since the procedure is being performed in a patient's mouth, and pulpal damage could begin to occur at that point. Therefore; the utilization of elevated temperature for a dental composite is minimal, and the benefit of such is limited.

### SUMMARY OF THE INVENTION

These and other objects and advantages are accomplished by the method of the present invention for use with photo-initiated polymerizable dental compositions. The method comprises preheating a tooth restoration precursor of a defined shape or anatomy in a temperature range from about 65°-120° C. for a length of time for the temperature to reach a temperature equilibrium. The time preferably ranges from about 1 minute to 30 minutes, more preferably from about 1 to about 15 minutes and most preferably less than about ten minutes. Thereafter, the dental composition is light cured to polymerize the dental restoration. The restoration produced through this process will have at least 10% or higher strength than the dental restorations made by conventional methods.

### DESCRIPTION OF THE INVENTION

As will be appreciated, the present invention provides high strength dental composite materials. The process herein is useful in the dental laboratory in the fabrication of dental restorative materials that are subsequently sent to the dentist for placement in the patient's mouth. The dental restorative materials include single and multi-unit dental materials not limited to orthodontic appliances, bridges, space maintainers, tooth replacement appliances, splints, crowns, partial crowns, dentures, posts, teeth, jackets, inlays, onlays, facings, veneers, facets, implants, abutments, cylinders, and connectors.

The process involves forming a composite material comprising a photo-initiated polymerizable reactive monomer into the desired dental restorative shape. The molded or formed shape is then preheated at a temperature in the range from about 65° C. to about 120° C., preferably from about 70° C. to about 110° C. and more preferably from about 75° C. to about 100° C., for a period of time in order for the composite material to reach a temperature equilibrium. It is thought that this preheating step creates higher double bond conversions of the monomer upon light curing polymerization, which gives improved strength to the composite compositions. Without being bound to any theory, the elevated temperature may further aid in softening the viscosity of the composite mass, increasing the resin functional mobility, relaxing any stress from the restoration build-up process, reorganizing the resin molecular orientation, and freeing or minimizing voids within the mass. All of these effects will help to improve the properties of the cured mass. Following this preheating step, the preheated shape is immediately light cured to promote full polymerization of the monomer to harden the dental restorative shape.

As described above, the process herein is for use with light-curable dental restorative composites wherein a photoinitiator is present to initiate curing by light radiation. The composition-comprises a polymerizable component, i.e., at least one polymerizable monomer or prepolymer selected from those known in the art of dental materials, including but not being limited to, resins having (1) free radically active functional groups, (2) cationically active functional groups, and (3) both free radically and ionically active groups.

Examples of free radical polymerizable resins include, but are not limited to those resins with ethylenically unsaturated functional groups such as (meth)acrylates, vinyl monomers such as styrene, vinyl esters, a variety of unsaturated cyclic monomers such as spiro ortho carbonates, esters, vinyl cyclic ethers and cyclic acetals.

Examples of resins having ionically active functional groups include, but are not limited to, vinyl ethers, ring-opening cationic or anionic ring-opening of a variety of cyclic monomers such as epoxies, siloranes, lactide, ε-caprolactones and ε-caprolactam.

Examples of resins containing both free radical and ionically curable functional groups include, but are not limited to, the resin oligomers having both an epoxy functionality and a (meth)acrylate functionality as set forth in commonly owned, copending U.S. patent application Ser. No. 10/452,269 filed Jun. 2, 2003, which is hereby incorporated by reference.

Preferred polymerizable monomers are ethylenically unsaturated and include those based on acrylic and methacrylic monomers, for example those disclosed in U.S. Pat. No. 3,066,112, U.S. Pat. No. 3,179,623, and U.S. Pat. No. 3,194,784 to Bowen; U.S. Pat. No. 3,751,399 and U.S. Pat. No. 3,926,906 to Lee et al.; and commonly assigned U.S. Pat. No. 5,276,068 to Waknine, all of which are herein incorporated by reference in their entirety. Methacrylate-based monomers are particularly preferred, including the condensation product of bisphenol A and glycidyl methacrylate, 2,2′-bis [4-(3-methacryloxy-2-hydroxy propoxy)-phenyl]-propane (“BIS-GMA”), dipentaerythritol pentaacrylate (DPEPA), pentaerythritol dimethacrylate (PEDM), the condensation product of ethoxylated bisphenol A and glycidyl methacrylate (“EBPA-DMA”), and the condensation product of 2 parts hydroxymethylmethacrylate and 1 part triethylene glycol bis(chloroformate) (“PCDMA”). Polyurethane-based dimethacrylates (“PUDMA”) and polycarbonate modified-BisGMA (PCBisGMA) and other monomers set forth in commonly owned, copending U.S. patent application Ser. No. 10/287,428, which is hereby incorporated by reference, are also within the scope of the present invention.

The polymerizable component may further comprise additional polymerizable diluent monomers. Such monomers are generally used to adjust the viscosity of the polymerizable composition. Suitable methacrylate-based diluent monomers include, without limitation, hydroxyalkyl methacrylates, such as 2-hydroxyethyl methacrylate, 1,6-hexanediol dimethacrylate, and 2-hydroxypropyl methacrylate; glyceryl dimethacrylate; and ethylene glycol methacrylates, including ethylene glycol methacrylate, diethyleneglycol methacrylate, triethyleneglycol methacrylate and tetraethyleneglycol methacrylate. Triethyleneglycol dimethacrylate (“TEGDMA”) is particularly preferred.

The dental restorative composition furthermore includes a polymerization photoinitiator system for light curing the polymeric material. The light cure system is selected from known light-activated polymerization initiators, including but not being limited to benzil, benzoin, benzoin methyl ether, DL-camphorquinone (CQ) and benzil diketones. Either UV-activated cure or visible light-activated cure (approx. 230 to 750 nm) is acceptable. The amount of photoinitiator is selected according to the curing rate desired. A minimally catalytically effective amount is generally about 0.01% by weight of the polymeric components. Faster rates of cure are achieved with amounts of catalyst in the range from greater than about, 0.01% to about 5% by weight of the polymeric component. Visible light curing systems furthermore preferably comprise polymerization accelerators, which include various organic tertiary amines well known in the art. In visible light curable compositions, the tertiary amines can be acrylate derivatives such as dimethylaminoethyl methacrylate and, particularly, diethylaminoethyl methacrylate (“DEAME”) and aromatic tertiary amines such as ethyl dimethylamino benzoate (EDMAB) in amounts in the range from about 0.05 to about 2 weight percent and preferably from about 0.1 to about 0.5 weight percent.

The dental restorative compositions may also comprise other additives and solvents known in the art, for example, ultra-violet light absorbers, anti-oxidants such as BHT, stabilizers, fillers, pigments, opacifiers, handling agents, and others. It is preferred to employ an ultraviolet absorber in amounts ranging from about 0.05 to about 5.0 weight percent. Such UV absorbers are particularly desirable in these visible light curable compositions in order to avoid discoloration of the resin from any incident ultraviolet light. Suitable UV absorbers are the various benzophenones, particularly UV-9 and UV-5411 available from American Cyanamid Company, and benzotriazoles known in the art, particularly 2-(2′-hydroxy-5′-methylphenyl)-benzotriazole, sold under the trademark TINUVIN P by Ciba-Geigy Corporation, Ardsley, N.Y.

Fillers, such as particulate and fibers, colloidal silica, barium glasses, fibrous fillers, quartz, ceramic fillers and the like may also be incorporated into the compositions. Suitable fillers include fillers conventionally used in the dental industry capable of being covalently bonded to the resin matrix itself or to a coupling agent which is covalently bonded to both. Silane coupling agents are known, for example methacryloxypropyl trimethoxy silane. Such fillers are described in U.S. Pat. Nos. 4,544,359 and 4,547,531, the pertinent portions of which are hereby incorporated by reference. Examples of suitable filling materials include but are not limited to amorphous silica, spherical silica, colloidal silica, barium glasses, quartz, ceramic fillers, silicate glass, hydroxyapatite, calcium carbonate, fluoroaluminosilicate, barium sulfate, quartz, barium silicate, strontium silicate, barium borosilicate, barium boroaluminosilicate, strontium borosilicate, strontium boroaluminosilicate, glass fibers, lithium silicate, ammoniated calcium phosphate, deammoniated calcium phosphate, alumina, zirconia, tin oxide, polymer powders such as, polymethyl methacrylate, polystyrene, and polyvinyl chloride, titania, bound, nanostructured, silica fillers as set forth in commonly owned U.S. Pat. No. 6,417,246, which is hereby incorporated by reference, densified, embrittled glass fibers or particles as set forth in commonly owned U.S. Pat. Nos. 6,013,694 and 6,403,676, which are hereby incorporated by reference, fibrous material and one or more forms of surface-modifying particles bonded thereto as set forth in commonly owned U.S. Pat. No. 6,270,562, which is hereby incorporated by reference, and polyhedral oligomeric silsesquioxane fillers as set forth in U.S. Pat. No. 6,653,365, which is hereby incorporated by reference, and combinations of all the fillers mentioned. Particularly suitable fillers for dental filling-type materials prepared are those having a particle size in the range from about 0.1 to about 5.0 microns, together with a silicate colloid having particle sizes in the range from about 0.001 to about 0.07 microns.

In accordance herein, the dental restoration is molded into the desired form using a polymeric composite material, as described above. The molded shape is then preheated at a temperature in the range from about 65° C. to about 120° C. for a period of time such that the composite reaches temperature equilibrium in the desired range. The molded shape may be maintained at this temperature for about 1 to about 30 minutes, preferably for about 1 to about 15 minutes, and most preferably less than about 10 minutes, before it is subjected to light curing. Thereafter the material is subjected to light curing to fully harden the dental restoration. It is preferable that the high temperature (i.e., between about 65° and 120° C.) is maintained during the light curing step to obtain optimal benefits from the process. After curing, the restoration may be further subjected to surface grinding, trimming, finishing, polishing and cleaning before being delivered into the patient's mouth. The restoration is now ready for placement in the patient's mouth with a conventional cementation media as preferred by a dentist.

In accordance with another aspect of the invention herein, a curing apparatus is provided wherein a polymeric dental material may be heated at the preheating temperature range of from about 65° C. to about 120° C. The polymeric dental material may be further light cured in the same apparatus, optionally allowing for the temperature to be maintained while light curing is performed. The apparatus may include two separate compartments, one for preheating and one for light curing, or it may include a single compartment wherein preheating and light curing are performed. The preheating step is performed prior to light curing and may be maintained during the light curing operation.

The following examples do not limit, but further illustrate the invention.

### EXAMPLE 1

A light curable only Sculpture Plus™ restorative composite material, Shade A2, lot# 75806 (available from Pentron Laboratory Technologies, LLC, Wallingford, Conn.) was used for this strength test. The test sample size was 2×2×25 mm as defined by ISO Specification No. 4049 for dental resin based restorative materials. The composite material was packed into a metal mold and covered with glass slides on both sides. The whole ensemble was then placed into an oven with a preset temperature as indicated in the Table 1 below for 15 minutes to reach temperature equilibrium. Immediately after heating at the predetermined temperature, the whole ensemble was immediately placed (within 5 seconds) into the Cure-Lite Plus™ curing light unit for 4 minutes of photo-curing. Six samples for each test group were prepared. The samples were trimmed to remove any excess and aged for 24 hours in water at 37° C. before performing the three-point bend flexural strength test with an ATS machine. The results are as listed in the Table 1 below.

TABLE 1

| | | Percent Strength |
|---|---|---|
| Sculpture Plus | Three- | Increase Resulting |
| composite preheated | Point Bend Test | From Heating Above |
| for 15 min. at the | (flexural strength) | 65° C. In Comparison |
| following temperatures | (psi) (SD) | to No Heating |
| No heating | 19476(2019) | |
| (about 20° C.) | | |
| 40° C. | 20678(1386) | |
| 70° C. | 22656(1222) | 16.32% |
| 120° C. | 21650(2320) | 11.16% |

### EXAMPLE 2

Commercial light curable dental restorative composites designed for direct dentist use or indirect lab technician use were tested for resistance to crush. Alert® composite (available from Pentron Clinical Technologies, LLC, Wallingford, Conn.) is a tooth filling material used by a dentist at chairside. The material was tested here to illustrate the preheating effects to a dental resin composite material. Sculpture® and Sculpture® Plus composites are two generations of laboratory restorative composites that have different resin matrix compositions as disclosed in U.S. Pat. Nos. 5,276,068, 5,969,000, 4544,359, and 5,444,104, and U.S. application Ser. No. 10/287,428, all of which are commonly assigned and which are hereby incorporated by reference. FiberKor® material is a resin pre-impregnated unidirectional glass fiber containing strip material used to reinforce a dental restoration made from a resin composite material such as Sculpture® composite or Sculpture® Plus composite. All these materials are available from Pentron Laboratory Technologies, LLC.

To make a composite dental crown, a single sized tooth die formed from a #3 core form (available from Pentron Laboratory Technologies, LLC, under the product name of Build-It® Core Forms—Core Build-It® Caps) was duplicated with a dental impression material using the conventional method of impression-taking and stone-pouring with a dental gypsum/stone material. Dental crowns/caps were fabricated on the tooth dies with a larger-sized transparent crown form (size #6) as a cap to sit onto the tooth die with sufficient materials filled in. The assemblies were then subjected to various pre-heating temperature settings for 5 minutes in a digitized Boekel lab oven (Model 133000) (Boekel Industrial, Inc.) immediately before placing into the Cure-Lite Plus curing unit for 4 minutes. Using the crown forms to fabricate the testing crowns will ensure the uniform sizes/forms of the crowns formed and make the testing results relevant. After the composite crowns/caps were polymerized, the flexible transparent core form caps were lifted and removed from the composite crowns. The hardened composite crowns/caps were subsequently removed from the stone dies. Further trimming on the edges of the crowns to remove any excess material was performed where necessary before putting the crowns into water and aging for 24 hour at 37° C. Each set of testing crowns had six samples. The crowns/caps were placed onto a flat platform and crushed under the compression mode with a crosshead speed of 0.2 in/min. with an ATS Model 1105 testing machine (Applied Testing Systems, Inc.). The maximum load at which the crown was fractured and detected by the machine was recorded in the force unit of pounds (lb). The average and standard deviations were calculated by the machine after the testing was finished.

The testing results from the experiments show that preheating a light curable dental composite at a temperature in the range from about 65° to about 120° C., followed by immediate light polymerization can increase the strength of the cured material or resistance to crush by at least 10 percent. The results are shown in Table 2 below.

TABLE 2

| | Resistance to Crush | Resistance to Crush | Resistance to Crush | Resistance to Crush |
|---|---|---|---|---|
| | For Polymerization | For Polymerization | For Polymerization | For Polymerization |
| Test Materials | at Room Temp. (lbs) | at 40° C. (lbs) | at 70° C. (lbs) | at 90° C. (lbs) |
| Alert ® composite | 292.7 (49.2) | — | 451.2 (90.0) | — |
| Sculpture ® composite | 299.1 (89.6) | — | — | 358.4 (100.9) |
| Sculpture ® Plus composite | 267.9 (84.5) | 344.2 (77.1) | 445.8 (162.4) | — |
| Sculpture ® Plus composite | 442.9 (122.4) | 475.8 (123.6) | 531.0 (194.3) | 526.1 (167.8) |
| with a layer of FiberKor ® | | | | |
| fiber embedded therein | | | | |

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A method of manufacturing a dental restoration from composite material comprising a photo-initiated polymerizable reactive monomer comprising:
(a) forming the composite material into a desired dental restorative shape;
(b) preheating the shaped composite material in the temperature range from about 65° C. to about 120° C. for a sufficient time to reach an equilibrium;
(c) light curing the shaped composite material to effect polymerization of the monomer to fully harden the dental restorative shape into the dental restoration for placement in a patient's mouth.

2. The method of claim 1 further comprising placing the dental restoration in a patient's mouth.

3. The method of claim 1 wherein the photo-initiated polymerizable reactive monomer comprises (1) a resin having free radically active functional groups, (2) a resin having cationically active functional groups, or (3) a resin having a mixture of both free radically and ionically active functional groups.

4. The method of claim 3 wherein the resin having free radically active functional groups comprises ethylenically unsaturated functional groups.

5. The method of claim 4 wherein the ethylenically unsaturated functional groups comprise (meth)acrylates, vinyl monomers, unsaturated cyclic monomers, or a mixture thereof.

6. The method of claim 5 wherein the vinyl monomers comprise styrene, vinyl esters or a mixture thereof.

7. The method of claim 5 wherein the unsaturated cyclic monomers comprise spiro ortho carbonates, esters, vinyl cyclic ethers, cyclic acetals or a mixture thereof.

8. The method of claim 3 wherein the resin having cationically active functional groups comprises vinyl ethers, ring-opening cationic cyclic monomers, anionic ring-opening cyclic monomers, or mixtures thereof.

9. The method of claim 8 wherein the ring-opening cationic cyclic monomers and the anionic ring-opening cyclic monomers comprise epoxies, siloranes, lactide, ε-caprolactones, ε-caprolactam or mixtures thereof.

10. The method of claim 3 wherein the resin having a mixture of both free radically and ionically active functional groups comprises an oligomer having both an epoxy functionality and a (meth)acrylate functionality.

11. The method of claim 1 wherein the photo-initiated polymerizable reactive monomer comprises an acrylic monomer, a methacrylic monomer or a mixture thereof.

12. The method of claim 1 wherein the photo-initiated polymerizable reactive monomer comprises at least one component selected from the group consisting of the condensation product of bisphenol A and glycidyl methacrylate, 2,2′-bis [4-(3-methacryloxy-2-hydroxy propoxy)-phenyl]-propane (“BIS-GMA”), dipentaerythritol pentaacrylate (DPEPA), pentaerythritol dimethacrylate (PEDM), the condensation product of ethoxylated bisphenol A and glycidyl methacrylate (“EBPA-DMA”), the condensation product of 2 parts hydroxymethylmethacrylate and 1 part triethylene glycol bis(chloroformate) (“PCDMA”), polyurethane-based dimethacrylates (“PUDMA”), and polycarbonate modified-BisGMA (PCBisGMA).

13. The method of claim 3 wherein the photo-initiated polymerizable reactive monomer polymerizable component further comprises one or more polymerizable diluent monomers selected from the group consisting of hydroxyalkyl methacrylates, glyceryl dimethacrylate, and ethyleneglycol methacrylates.

14. The method of claim 13 wherein the hydroxyalkyl methacrylates are selected from 2-hydroxyethyl methacrylate, 1,6-hexanediol dimethacrylate, and 2-hydroxypropyl methacrylate.

15. The method of claim 13 wherein the ethyleneglycol methacrylates are selected from ethyleneglycol methacrylate, diethyleneglycol methacrylate, triethyleneglycol methacrylate, tetraethyleneglycol methacrylate and triethyleneglycol dimethacrylate (“TEGDMA”).

16. The method of claim 1 wherein the composite material further comprises a filler material selected from the group consisting of particulate fillers, fibers and mixtures thereof.

17. The method of claim 1 wherein the composite material further comprises one or more of fillers selected from the group consisting of bound, nanostructured, silica, amorphous silica, spherical silica, colloidal silica, barium glasses, quartz, ceramic fillers, silicate glass, hydroxyapatite, calcium carbonate, fluoroaluminosilicate, barium sulfate, barium silicate, strontium silicate, barium borosilicate, barium boroaluminosilicate, strontium borosilicate, strontium boroaluminosilicate, glass fibers or particles, lithium silicate, ammoniated calcium phosphate, deammoniated calcium phophate, alumina, zirconia, tin oxide, polymer powders, polymethyl methacrylate, polystyrene, polyvinyl chloride, titania, fluoride, polyhedral oligomeric silsesquioxane and combinations thereof.

18. The method of claim 17 wherein the colloidal silica comprise a silicate colloid having particle sizes in the range from about 0.001 to about 0.07 microns.

19. The method of claim 17 wherein the glass fibers or particles comprise densified, embrittled glass fibers or particles.

20. The method of claim 1 wherein the composite material further comprises one or more of additives selected from the group consisting of colorants, stabilizers, whitening agents, antioxidants, photosensitizers and medicaments.

21. The method of claim 1 wherein preheating is carried out for a period of time from about 1 to about 30 minutes.

22. The method of claim 1 wherein preheating is carried out for a period of time from about 1 to about 15 minutes.

23. The method of claim 1 wherein preheating is carried out for a period of time of less than about 10 minutes.

24. The method of claim 1 further comprising maintaining the heat in the range from about 65° C. to about 120° C. during the light curing step.

25. The method of claim 1 further comprising maintaining the heat in the range from about 70° C. to about 110° C. during the light curing step.

26. The method of claim 1 further comprising maintaining the heat in the range from about from about 75° C. to about 100° C. during the light curing step.

27. A dental restoration formed by the process of claim 1.

28. The dental restoration of claim 27 have a flexural strength greater than about 10% or more of the strength of the same restoration not preheated when measured by ISO specification No. 4049.

29. A dental restoration comprising a composite material comprising a photo-initiated polymerizable reactive monomer formed by method of
(a) forming the composite material into a desired dental restorative shape;
(b) preheating the shaped composite material in the temperature range from about 65° C. to about 120° C. for a sufficient time to reach an equilibrium;
(c) light curing the shaped composite material to effect polymerization of the monomer to fully harden the dental restorative shape into the dental restoration for placement in a patient's mouth.

30. An apparatus for manufacturing a dental restoration from composite material comprising a photo-initiated polymerizable reactive monomer comprising:
a compartment for preheating and maintaining the temperature of the composite; and
a compartment for light curing the composite.

31. The apparatus of claim 30 wherein the compartment for preheating the composite and a compartment for light curing the composite comprise a single compartment.

32. The apparatus of claim 29 wherein the compartment for preheating and maintaining the temperature comprises a temperature control for preheating and maintaining temperature in the range from about 65° C. to about 120° C.
